(19) United States
(12) Patent Application Publication
(10) Pub. No.: US 2025/0307186 A1
(43) Pub. Date: Oct. 2, 2025

(54) INTERRUPT COALESCING DURING PROCESSOR IDLE

(71) Applicant: Advanced Micro Devices, Inc., Santa Clara, CA (US)

(72) Inventors: Elliot H. Mednick, Boxborough, MA (US); Indrani Paul, Austin, TX (US); Alexander J. Branover, Boxborough, MA (US); Benjamin Tsien, Santa Clara, CA (US); Narendra Kamat, Austin, TX (US)

(73) Assignee: Advanced Micro Devices, Inc., Santa Clara, CA (US)

(21) Appl. No.: 18/620,719

(22) Filed: Mar. 28, 2024

(51) Int. Cl. G06F 13/24

(52) U.S. Cl. CPC G06F 13/24

(57) ABSTRACT

The disclosed device includes a processor that receives interrupts from one or more processor components, and a control circuit that can delay, in response to the processor entering an idle state, the processor component from sending interrupts to the processor. Various other methods, systems, and computer-readable media are also disclosed.

### BACKGROUND

A processor can execute code as part of a program as well as handle interrupts that occur in response to runtime hardware and/or software events outside of a normal part of the program. During times of no active tasks required of the processor, the processor can enter an idle or low power state to reduce power consumption. If the processor receives an interrupt during the idle state, the processor can wake up to handle the interrupt. However, due to the sporadic or otherwise unpredictable nature of interrupts, maintaining a sufficient idle state between interrupts to realize power savings can be difficult.

### BRIEF DESCRIPTION OF THE DRAWINGS

The accompanying drawings illustrate a number of exemplary implementations and are a part of the specification. Together with the following description, these drawings demonstrate and explain various principles of the present disclosure.

FIG. 1 is a block diagram of an exemplary system for interrupt coalescing during processor idle.

FIG. 2 is a timing diagram of interrupt coalescing during processor idle.

FIG. 3 is a flow diagram of an exemplary method for interrupt coalescing during processor idle.

FIG. 4 is a flow diagram of an exemplary method for interrupt coalescing during processor idle.

Throughout the drawings, identical reference characters and descriptions indicate similar, but not necessarily identical, elements. While the exemplary implementations described herein are susceptible to various modifications and alternative forms, specific implementations have been shown by way of example in the drawings and will be described in detail herein. However, the exemplary implementations described herein are not intended to be limited to the particular forms disclosed. Rather, the present disclosure covers all modifications, equivalents, and alternatives falling within the scope of the appended claims.

### DETAILED DESCRIPTION

The present disclosure is generally directed to interrupt coalescing during processor idle. As will be explained in greater detail below, implementations of the present disclosure delay interrupts when a processor enters an idle or low power state. For example, various compute block that send runtime interrupts to the processor can be instructed to delay sending interrupts. When the processor exits the idle states, the interrupts can resume, for example instructing the compute blocks to send delayed interrupts as well as resume sending interrupts normally. The processor advantageously can remain in the idle state without being woken up by an interrupt.

In one implementation, a device for interrupt coalescing during processor idle includes a processor configured to receive interrupts from a processor component, and a control circuit configured to delay, in response to the processor entering an idle state, the processor component from sending interrupts to the processor.

In some examples, the processor component is configured to delay sending interrupts to the processor by using a delay timer for each interrupt. In some examples, a delay time for the delay timer corresponds to an idle duration of the idle state of the processor. In some examples, the idle duration corresponds to a duty cycle policy for the processor. In some examples, a delay time for the delay timer corresponds to a delay tolerance based on a priority of a corresponding interrupt. In some examples, the processor component is configured to send an interrupt when a corresponding delay timer expires. In some examples, the processor component is configured to cancel the delay timers when the processor exits the idle state.

In some examples, the control circuit is configured to allow, in response to the processor exiting the idle state, the processor component to send delayed interrupts to the processor. In some examples, the control circuit is configured to resume, in response to the processor exiting the idle state, the processor component sending interrupts to the processor. In some examples, the processor component is configured to send a high priority interrupt to the processor during the idle state. In some examples, the control circuit is configured to merge delayed interrupts.

In one implementation, a system for interrupt coalescing during processor idle includes a processor, a control circuit configured to initiate entry to an idle state of the processor for an idle duration and initiate exit of the idle state afterthe idle duration elapses, and a plurality of processor components each configured to delay, in response to the processor entering the idle state, sending interrupts to the processor, and send, in response to the processor exiting the idle state after the idle duration, delayed interrupts and to resume sending interrupts.

In some examples, each of the plurality of processor components is configured to delay sending interrupts to the processor by using a delay timer for each interrupt. In some examples, a delay time for the delay timer corresponds to at least one of the idle duration or a delay tolerance based on a priority of a corresponding interrupt. In some examples, each of the plurality of processor components is configured to send an interrupt when a corresponding delay timer expires. In some examples, each of the plurality of processor components is configured to cancel the delay timers in response to an instruction from the control circuit to send delayed interrupts.

In some examples, at least one of the plurality of processor components is configured to send a high priority interrupt to the processor during the idle state. In some examples, the idle duration corresponds to a duty cycle policy managed by the control circuit for the processor. In some examples, the control circuit is configured to hold delayed interrupts in a buffer and merge buffered interrupts.

In one implementation, a method for interrupt coalescing during processor idle includes (i) entering an idle state of a processor, (ii) coalescing, in response to entering the idle state, interrupts to the processor during the idle state, (iii) exiting the idle state of the processor, and (iv) resuming, in response to exiting the idle state, interrupts to the processor.

In some examples, coalescing interrupts comprises delaying interrupts using delay timers having delay times corresponding to at least one of an idle duration of the processor or a delay tolerance based on a priority of a corresponding interrupt. In some examples, the method includes sending an interrupt at an earlier of a corresponding delay timer expiring or exiting the idle state of the processor.

Features from any of the implementations described herein can be used in combination with one another in accordance with the general principles described herein. These and other implementations, features, and advantages will be more fully understood upon reading the following detailed description in conjunction with the accompanying drawings and claims.

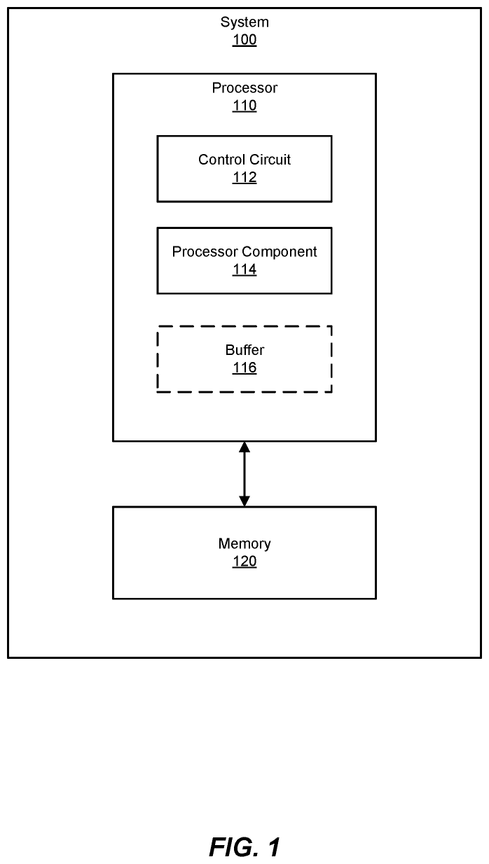

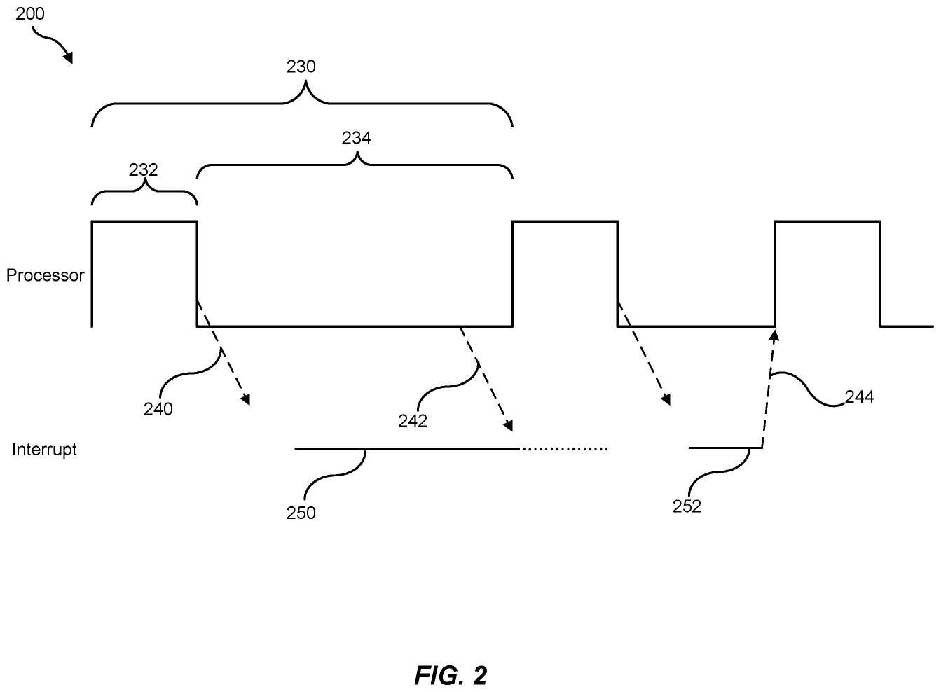

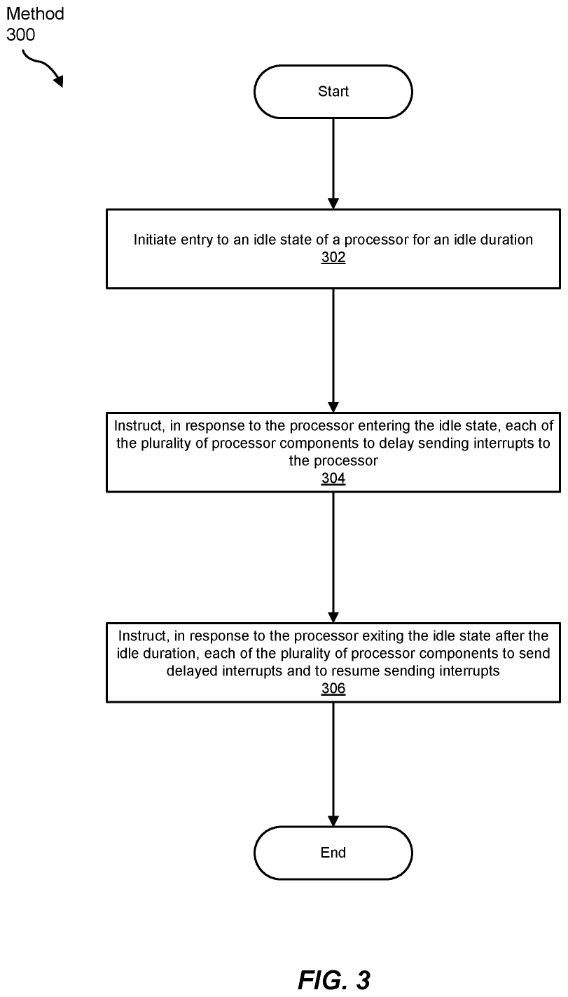

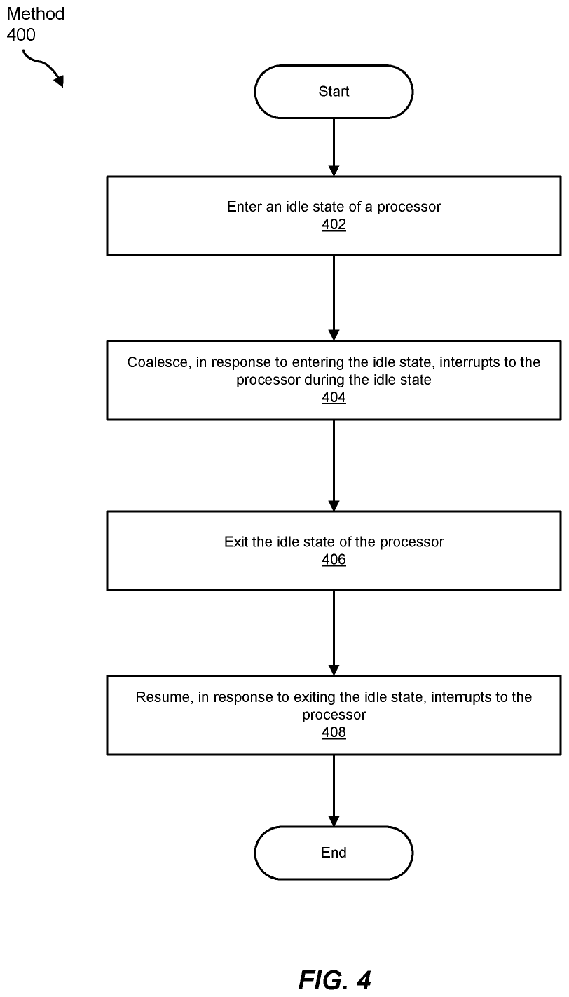

The following will provide, with reference to FIGS. 1-4, detailed descriptions of interrupt coalescing during processor idle. Detailed descriptions of example systems will be provided in connection with FIGS. 1 and 2. Detailed descriptions of corresponding methods will also be provided in connection with FIGS. 3 and 4.

FIG. 1 is a block diagram of an example system 100 for interrupt coalescing during processor idle. System 100 corresponds to a computing device, such as a desktop computer, a laptop computer, a server, a tablet device, a mobile device, a smartphone, a wearable device, an augmented reality device, a virtual reality device, a network device, and/or an electronic device. As illustrated in FIG. 1, system 100 includes one or more memory devices, such as memory 120. Memory 120 generally represents any type or form of volatile or non-volatile storage device or medium capable of storing data and/or computer-readable instructions. Examples of memory 120 include, without limitation, Random Access Memory (RAM), Read Only Memory (ROM), flash memory, Hard Disk Drives (HDDs), Solid-State Drives (SSDs), optical disk drives, caches, variations, or combinations of one or more of the same, and/or any other suitable storage memory.

As illustrated in FIG. 1, example system 100 includes one or more physical processors, such as processor 110. Processor 110 generally represents any type or form of hardware-implemented processing or compute unit capable of interpreting and/or executing computer-readable instructions. In some examples, processor 110 accesses and/or modifies data and/or instructions stored in memory 120. Examples of processor 110 include, without limitation, chiplets (e.g., smaller and in some examples more specialized processing units that can coordinate as a single chip), microprocessors, microcontrollers, Central Processing Units (CPUs), graphics processing units (GPUs), Field-Programmable Gate Arrays (FPGAs) that implement softcore processors, Application-Specific Integrated Circuits (ASICs), systems on chip (SoCs), digital signal processors (DSPs), Neural Network Engines (NNEs), accelerators, graphics processing units (GPUs), portions of one or more of the same, variations or combinations of one or more of the same, and/or any other suitable physical processor.

As further illustrated in FIG. 1, processor 110 includes a control circuit 112, a processor component 114, and in some implementations, a buffer 116. Control circuit 112 corresponds to circuitry and/or instructions for coordinating interrupt coalescing and in some implementations corresponds to and/or interfaces with a power management circuit and/or an interrupt management circuit. Processor component 114 corresponds to a component of processor 110 such as a compute block capable of sending interrupts (e.g., runtime interrupts triggered by software and/or hardware events outside of normal code execution) and in some examples corresponds to other processing component such as a chiplet for various processing, data storage, and/or input/output functionalities. Although FIG. 1 illustrates one processor component 114, in other examples, system 100 can include multiple iterations of processor component 114, which can be similar and/or different and further can be external to processor 110. Buffer 116 corresponds to a buffer (e.g., any data structure/circuit for at least temporarily storing one or more data elements/signals) for holding interrupts (e.g., delayed interrupts) and in some implementations is part of and/or otherwise interfaces with control circuit 112.

In some implementations, control circuit 112 can manage a duty cycle (e.g., a ratio or percentage of on/active time to off/idle time for a given cycle) of processor 110, for example enforcing a desired duty cycle for processor 110. FIG. 2 illustrates a timing diagram 200 for a system and/or processor, such as system 100 and/or processor 110. FIG. 2 illustrates a cycle 230 for processor 110, including an active duration 232 in which processor 110 is active/on (e.g., in an active state) and an idle duration 234 in which processor 110 is idle/off (e.g., in an idle or low power state).

In certain use cases and/or workloads of processor 110, a desired duty cycle can correspond to a duty cycle (and/or period of active state and idle state) for efficiently completing the workload or is otherwise efficient for the use case, which in some examples can correspond to a minimum or optimum active state for a cycle. As described herein, a cycle with respect to duty cycle can correspond to an appropriate period of time for comparing/defining duty cycles and in some examples can correspond to multiple clock cycles.

Control circuit 112 can apply a desired duty cycle for processor 110 by coordinating when processor 110 enters and exits the idle or low power state. For example, for cycle 230, control circuit 112 can instruct processor 110 with an idle entry 240 into the idle state after active duration 232 (based on the desired duty cycle) elapses. In addition, after idle duration 234 (based on the desired duty cycle) elapses, control circuit 112 can instruct processor 110 with an idle exit 242 from the idle state. Accordingly, control circuit 112 can enforce the desired duty cycle.

However, a runtime interrupt (e.g., from one or more iterations of processor component 114) can cause processor 110 to prematurely exit (e.g., before idle duration 234 elapses) the idle state. Due to the independent and asynchronous nature of runtime interrupts, it can be difficult to reliably predict interrupts to better time idle duration 234.

In some implementations, control circuit 112 can more effectively enforce the duty cycle policy by coalescing interrupts. For example, control circuit 112 can instruct the various compute blocks (e.g., one or more iterations of processor component 114) to delay sending interrupts during idle duration 234.

In one implementation, control circuit 112 can coordinate (e.g., instruct and/or detect) processor 110 to be active during active duration 232, in accordance with the duty cycle policy. As part of idle entry 240, control circuit 112 can initiate interrupt coalescing by instructing processor component 114 (and multiple different iterations thereof) to delay interrupts, such as to delay by a specified duration (e.g., idle duration 234) and/or indefinitely (e.g., until a resume instruction). In some examples, processor component 114 can delay interrupts by waiting until instructed by control circuit 112 to resume sending interrupts.

In some examples, processor component 114 can use a delay timer 250 for each delayed interrupt such that interrupts are sent when the delay timer expires. The delay time (indicated by the solid and broken line in FIG. 2) for the delay timer can correspond to idle duration 234 such that the delay timer would ensure that the interrupt is not sent during idle duration 234. Although each interrupt can have a corresponding delay timer (e.g., starting when each corresponding interrupt is generated), in some examples, a global delay timer (e.g., starting when instructions to delay are received during idle entry 240) can be applied for all interrupts.

After idle duration 234 elapses, control circuit 112 can, as part of idle exit 242, instruct processor component 114 to propagate interrupts. For example, processor component 114 can cancel any pending timers (indicated by the broken line segment for delay timer 250) and send corresponding interrupts to processor 110. In other words, the delay timers can expire at an earlier of the delay time elapsing or the idle state ending.

However, certain interrupts can be urgent or otherwise negatively affect performance if delayed too long. In some examples, processor component 114 can apply different delay times to the delay timers of urgent interrupts. For example, based on priority, interrupts can have different delay tolerances (including zero or no delay tolerance) such that processor component 114 can establish delay timers using the delay tolerances. Further, in some examples, control circuit 112 can coordinate with processor component 114 to establish priorities and delay tolerances of interrupts. In FIG. 2, an urgent interrupt can have a delay timer 252 having a delay tolerance shorter than idle duration 234. When delay timer 252 expires, processor component 114 can send the urgent interrupt to processor 110, causing a wake up event 244 the prematurely ends the idle state with respect to the duty cycle policy. Thus, processor component 114 can, in some implementations, send urgent interrupts that overrides the interrupt coalescing.

Although examples described herein describe coalescing interrupts by instructing compute blocks to delay sending interrupts, in some examples, interrupts can be coalesced by buffering interrupts such that the processor can handle the buffered interrupts after exiting the idle state. Further, the use of such buffer can in some examples be restricted to periods of interrupt coalescing.

FIG. 3 is a flow diagram of an exemplary method 300 for interrupt coalescing during processor idle. The steps shown in FIG. 3 can be performed by any suitable circuit, device, and/or computing system, including the system(s) illustrated in FIGS. 1 and/or 2. In one example, each of the steps shown in FIG. 3 represent an algorithm whose structure includes and/or is represented by multiple sub-steps, examples of which will be provided in greater detail below.

As illustrated in FIG. 3, at step 302 one or more of the systems described herein initiates entry to an idle state of the processor for an idle duration. For example, control circuit 112 can initiate entry to an idle state of processor 110.

The systems described herein can perform step 302 in a variety of ways. In one example, the idle duration corresponds to a duty cycle policy for the processor, as described herein.

At step 304 one or more of the systems described herein instructs, in response to the processor entering the idle state, each of the plurality of processor components to delay sending interrupts to the processor. For example, control circuit 112 can, as part of the idle state entry, instruct various iterations of processor component 114 to delay sending interrupts to processor 110.

The systems described herein can perform step 304 in a variety of ways. In one example, each of the plurality of processor components is configured to delay sending interrupts to the processor by using a delay timer for each interrupt. For instance, a delay time for the delay timer corresponds to at least one of the idle duration or a delay tolerance based on a priority of a corresponding interrupt, as described herein.

In some examples, each of the plurality of processor components is configured to send an interrupt when a corresponding delay timer expires. Further, in some examples, at least one of the plurality of processor components is configured to send a high priority interrupt to the processor during the idle state.

At step 306 one or more of the systems described herein instructs, in response to the processor exiting the idle state after the idle duration, each of the plurality of processor components to send delayed interrupts and to resume sending interrupts. For example, control circuit 112 can, as part of exiting the idle state, instruct the iterations of processor component 114 to send the delayed interrupts and to resume normal sending of interrupts.

The systems described herein can perform step 306 in a variety of ways. In one example, each of the plurality of processor components is configured to cancel the delay timers in response to the instruction to send delayed interrupts, as described herein.

FIG. 4 is a flow diagram of an exemplary method 400 for interrupt coalescing during processor idle. The steps shown in FIG. 4 can be performed by any suitable circuit, device, and/or computing system, including the system(s) illustrated in FIGS. 1 and/or 2. In one example, each of the steps shown in FIG. 4 represent an algorithm whose structure includes and/or is represented by multiple sub-steps, examples of which will be provided in greater detail below.

As illustrated in FIG. 4, at step 402 one or more of the systems described herein enters an idle state of a processor. For example, control circuit 112 initiates idle entry 240 of processor 110.

At step 404 one or more of the systems described herein coalesces, in response to entering the idle state, interrupts to the processor during the idle state. For example, control circuit 112 can, as part of idle entry 240, initiate interrupt coalescing.

The systems described herein can perform step 404 in a variety of ways. In one example, coalescing interrupts comprises delaying interrupts using delay timers having delay times corresponding to at least one of an idle duration of the processor or a delay tolerance based on a priority of a corresponding interrupt, as described herein. In other examples, control circuit 112 can enable a mechanism for pausing interrupts without dropping interrupts, such as by implementing a buffer (e.g., buffer 116) for holding received interrupts to be handled when coalescing ends. In some examples, the buffered interrupts can be merged or otherwise combined into fewer interrupts. For instance, interrupts targeting the same service routine can be merged into one interrupt while being queued in the buffer. In some implementations, merging interrupts can include combining interrupt signals/data, dropping or ignoring older interrupts (e.g., for repeated similar interrupts), changing characteristics/parameters, etc. In some implementations, control circuit 112 can include one or more buffers (e.g., one or more different instances of buffer 116) that each correspond to different types of interrupts (e.g., priority, service routine, interrupt handler, etc.) such that control circuit 112 can merge interrupts in respective buffers.

At step 406 one or more of the systems described herein exits the idle state of the processor. For example, control circuit 112 can initiate idle exit 242 of processor 110.

As illustrated in FIG. 4, at step 408 one or more of the systems described herein resumes, in response to exiting the idle state, interrupts to the processor. For example, control circuit 112 can, as part of idle exit 242, end interrupt coalescing by resuming interrupts to processor 110. In some examples, control circuit 112 can send buffered interrupts (e.g., delayed interrupts held in one or more buffers). In some implementations, control circuit 112 can send a reduced number of interrupts (e.g., sending fewer interrupts than were delayed/buffered). For instance, control circuit 112 can send interrupts that have been merged within buffer 116 as described herein.

The systems described herein can perform step 408 in a varietyof ways. In one example, resuming interrupts can include canceling pending delay timers. In some examples, sending an interrupt can occur at an earlier of a corresponding delay timer expiring or exiting the idle state of the processor. In yet other examples, resuming interrupts can include handling any buffered interrupts and/or disabling any such buffer.

As detailed above, for a system in a low power state, a wake activity such as an interrupt can come sporadically such that the low power state is not efficiently utilized. Runtime interrupt coalescing can ensure that the system sufficiently remains in the low power state to be effective. The coalescing can be based on use-case duty cycles. The interrupts can be duty cycled (e.g., matching a processor duty cycle) to have an active period of propagating interrupts to the system/SOC, and an idle period (low power). The interrupts can be held until a timer delay elapses. The timer delay can be based on an express latency tolerance for the interrupt, which can be further associated with each interrupt-sending entity.

Each entity can be associated with a latency tolerance. For example, input devices (keyboard, mouse) can be real time. Thermal events can have, in some examples, 1-2 ms delay. Based on the source of interrupt, timer delays can be used to delay interrupts until its timer delay expires, at which point the interrupt is propagated to the system/SOC. Thus, the timer delays can establish a duty cycle with an active period (propagating interrupts) and idle period.

The systems and methods described herein allows bursting of interrupts to allow sufficient idle periods, to make effective use of low power states. Using timer delays based on interrupt sources allows flexibility and ensuring that interrupts that would decrease performance/usability if delayed too long are not delayed more than an acceptable amount of time.

As detailed above, the circuits, devices and systems described and/or illustrated herein broadly represent any type or form of computing device or system capable of executing computer-readable instructions. In their most basic configuration, these computing device(s) each include at least one memory device and at least one physical processor.

In some examples, the term “memory device” generally refers to any type or form of volatile or non-volatile storage device or medium capable of storing data and/or computer-readable instructions. In one example, a memory device stores, loads, and/or maintains one or more of the modules and/or circuits described herein. Examples of memory devices include, without limitation, Random Access Memory (RAM), Read Only Memory (ROM), flash memory, Hard Disk Drives (HDDs), Solid-State Drives (SSDs), optical disk drives, caches, variations, or combinations of one or more of the same, or any other suitable storage memory.

In some examples, the term “physical processor” generally refers to any type or form of hardware-implemented processing unit capable of interpreting and/or executing computer-readable instructions. In one example, a physical processor accesses and/or modifies one or more modules stored in the above-described memory device. Examples of physical processors include, without limitation, microprocessors, microcontrollers, Central Processing Units (CPUs), Field-Programmable Gate Arrays (FPGAs) that implement softcore processors, Application-Specific Integrated Circuits (ASICs), systems on a chip (SoCs), digital signal processors (DSPs), Neural Network Engines (NNEs), accelerators, graphics processing units (GPUs), portions of one or more of the same, variations or combinations of one or more of the same, or any other suitable physical processor.

In some implementations, the term “computer-readable medium” generally refers to any form of device, carrier, or medium capable of storing or carrying computer-readable instructions. Examples of computer-readable media include, without limitation, transmission-type media, such as carrier waves, and non-transitory-type media, such as magnetic-storage media (e.g., hard disk drives, tape drives, and floppy disks), optical-storage media (e.g., Compact Disks (CDs), Digital Video Disks (DVDs), and BLU-RAY disks), electronic-storage media (e.g., solid-state drives and flash media), and other distribution systems.

The process parameters and sequence of the steps described and/or illustrated herein are given by way of example only and can be varied as desired. For example, while the steps illustrated and/or described herein are shown or discussed in a particular order, these steps do not necessarily need to be performed in the order illustrated or discussed. The various exemplary methods described and/or illustrated herein can also omit one or more of the steps described or illustrated herein or include additional steps in addition to those disclosed.

The preceding description has been provided to enable others skilled in the art to best utilize various aspects of the exemplary implementations disclosed herein. This exemplary description is not intended to be exhaustive or to be limited to any precise form disclosed. Many modifications and variations are possible without departing from the spirit and scope of the present disclosure. The implementations disclosed herein should be considered in all respects illustrative and not restrictive. Reference should be made to the appended claims and their equivalents in determining the scope of the present disclosure.

Unless otherwise noted, the terms “connected to” and “coupled to” (and their derivatives), as used in the specification and claims, are to be construed as permitting both direct and indirect (i.e., via other elements or components) connection. In addition, the terms “a” or “an,” as used in the specification and claims, are to be construed as meaning “at least one of.” Finally, for ease of use, the terms “including” and “having” (and their derivatives), as used in the specification and claims, are interchangeable with and have the same meaning as the word “comprising.”

What is claimed is:

1. A device comprising:
a processor configured to receive interrupts from a processor component; and
a control circuit configured to delay, in response to the processor entering an idle state, the processor component from sending interrupts to the processor.

2. The device of claim 1, wherein the processor component is configured to delay sending interrupts to the processor by using a delay timer for each interrupt.

3. The device of claim 2, wherein a delay time for the delay timer corresponds to an idle duration of the idle state of the processor.

4. The device of claim 3, wherein the idle duration corresponds to a duty cycle policy for the processor.

5. The device of claim 2, wherein a delay time for the delay timer corresponds to a delay tolerance based on a priority of a corresponding interrupt.

6. The device of claim 2, wherein the processor component is configured to send an interrupt when a corresponding delay timer expires.

7. The device of claim 2, wherein the processor component is configured to cancel the delay timers when the processor exits the idle state.

8. The device of claim 1, wherein the control circuit is configured to allow, in response to the processor exiting the idle state, the processor component to send delayed interrupts to the processor.

9. The device of claim 1, wherein the control circuit is configured to resume, in response to the processor exiting the idle state, the processor component sending interrupts to the processor.

10. The device of claim 1, wherein the processor component is configured to send a high priority interrupt to the processor during the idle state.

11. The device of claim 1, wherein the control circuit is configured to merge delayed interrupts.

12. A system comprising:
a processor;
a control circuit configured to initiate entry to an idle state of the processor for an idle duration and initiate exit of the idle state after the idle duration elapses; and
a plurality of processor components each configured to:
delay, in response to the processor entering the idle state, sending interrupts to the processor; and
send, in response to the processor exiting the idle state after the idle duration, delayed interrupts and to resume sending interrupts.

13. The system of claim 12, wherein:
each of the plurality of processor components is configured to delay sending interrupts to the processor by using a delay timer for each interrupt;
a delay time for the delay timer corresponds to at least one of the idle duration or a delay tolerance based on a priority of a corresponding interrupt; and
each of the plurality of processor components is configured to send an interrupt when a corresponding delay timer expires.

14. The system of claim 13, wherein each of the plurality of processor components is configured to cancel the delay timers in response to an instruction from the control circuit to send delayed interrupts.

15. The system of claim 12, wherein at least one of the plurality of processor components is configured to send a high priority interrupt to the processor during the idle state.

16. The system of claim 12, wherein the idle duration corresponds to a duty cycle policy managed by the control circuit for the processor.

17. The system of claim 12, wherein the control circuit is configured to hold delayed interrupts in a buffer and merge buffered interrupts.

18. A method comprising:
entering an idle state of a processor;
coalescing, in response to entering the idle state, interrupts to the processor during the idle state;
exiting the idle state of the processor; and
resuming, in response to exiting the idle state, interrupts to the processor.

19. The method of claim 18, wherein coalescing interrupts comprises delaying interrupts using delay timers having delay times corresponding to at least one of an idle duration of the processor or a delay tolerance based on a priority of a corresponding interrupt.

20. The method of claim 19, further comprising sending an interrupt at an earlier of a corresponding delay timer expiring or exiting the idle state of the processor.
